(19) United States
(12) Patent Application Publication
(10) Pub. No.: US 2004/0200902 A1
(43) Pub. Date: Oct. 14, 2004

(54) Method for marking an information label on a product

(75) Inventor: Takahiro Ishioroshi, Kanagawa (JP)

Correspondence Address: SUGHRUE MION, PLLC, 2100 Pennsylvania Avenue, N.W., Washington, DC, 20037-3213, US

(73) Assignee: FUJI PHOTO FILM CO., LTD.

(21) Appl. No.: 10/820,887

(22) Filed: Apr. 9, 2004

(30) Foreign Application Priority Data
Apr. 11, 2003 (JP) 2003-107188

(51) Int. Cl. G06K 19/06

(52) U.S. Cl. 235/491

(57) ABSTRACT

A method for marking an information label on a product is provided, which has the step of printing the information label on the product. The method employs a fluorescent ink which emits light under illumination of ultraviolet light.

### BACKGROUND OF THE INVENTION

The present invention pertains to a method for marking an information label, and more particularly, to a method for marking various types of information label on a product.

Various types of information associated with such as product control and product identification have been marked, using printing and the like, on plastic cases prepared for a magnetic tape cartridge, magnetic tape cassette, ink ribbon cartridge for thermal transfer print and a recording medium such as CD-R and DVD-R. For example, the information includes a manufacturing date, manufacturing lot number and the like.

Marking of an information label has been implemented by printing a combination of numbers, characters and symbols or a code such as a bar code and two-dimensional code. Japanese Published Patent Applications 2002-373479 and 2002-367336 report the related arts.

However, for example, when the color of a product and that of an ink used for printing the information label are similar, there has been a problem that it is difficult to clearly recognize the information label printed on the product. Especially, it is necessary for the information label to have relative lightness with regard to the color of product so that a machine or man can read its contents. Because the color of product is prioritized so as to identify it or distinguish it from other brands, it has been troublesome to select an appropriate color of ink as the case may be so that a difference in lightness can be established between the colors of product and ink. Furthermore, another type of problem has been posed that the ink used for the information label is too loud due to the unbalance of lightness relative to the color of product. For example, in case of a white ink used for the information label on a black product, the ink gives unnaturally striking impression. This results in spoiling the appearance of product or imposing restriction on its design.

### SUMMARY OF THE INVENTION

The present invention seeks to provide a method for marking an information label on a product, which is able to solve the problem described above.

A method for marking an information label on a product is provided, which has the step of printing the information label on the product. The method employs a fluorescent ink which emits light under illumination of ultraviolet light.

The method described above does not spoil the appearance of product because the information label is invisible unless it is illuminated with ultraviolet light for excitation. It does not impose design restriction on the product, either. Furthermore, the method allows an easy checking of the information label when it is necessary by illuminating the label with the ultraviolet light.

Marking of an information label according to the present invention includes printing of numbers, characters, symbols, their combination, a bar code and a two-dimensional code, which represent various types of information for product control and identification of a product such as manufacturing date and lot number.

Following are examples of method which may be preferable for printing of the information label on the product. A first method uses a hot-stamp foil including a fluorescent ink. An information label is formed with the hot-stamp foil, which is affixed to the product. A second method uses the same type of hot-stamp foil as that of the first method and its blank part is removed. A third method uses ink jet printing, pad printing and the like, which directly apply the fluorescent ink to the product.

It may be preferable that the hot-stamp foil including the fluorescent ink or the ink itself contains a substance which is invisible under visible light conditions and excited to emit light under illumination of ultraviolet light. In this way, the printed information label, which is invisible while it is exposed to visible light, does not spoil the appearance of a product or impose restriction on its design. Therefore, being free from the restriction stemming from a color applied to the information label, it may be possible to arbitrarily select desirable colors in order to identify the product, distinguish it from those of other brands and elaborate its design.

It may also be preferable that the fluorescent ink emits light in a range of wavelength, which is different from that of the ultraviolet light used for exciting the ink. This will provide better visibility in checking of the information label. It may especially be preferable if the ink emits visible light under illumination of the ultraviolet light. It may also be preferable to adopt a plurality of fluorescent inks, which emit light in different wavelengths, so that different information labels can be marked on a product. This will provide an efficient method because it is possible to distinguish the information labels one from another, by introducing the different wavelengths of light which the fluorescent inks emit, respectively.

The method for marking an information label on a product described above can be beneficially applied to products such as a magnetic tape cartridge, magnetic tape cassette and cartridge of ink ribbon for thermal transfer printing. Marking of the information label may also be applied to their cases made of plastic. For example, such information as the control number for a product under manufacturing, manufacturer and identification (such as manufacturing date and lot number) can be recorded on the information label. After manufacturing, it may be possible to read the information label whenever it is necessary.

Furthermore, it may be preferable to read the information label through a filter cutting the ultraviolet light illuminated so as to excite the fluorescent ink. This allows stable reading of the information label because the filter prevents not only light reflected from the product but also the color applied to it from creating an adverse effect on reading.

### BRIEF DESCRIPTION OF THE DRAWINGS

FIG. 1 is a perspective view showing a video tape cassette.

FIG. 2 is a enlarged front view showing a two-dimensional code for a video tape cassette.

FIG. 3 is a schematic diagram illustrating the relationship between exciting ultraviolet light and a spectrum of fluorescent light for a two-dimensional code of a video tape cassette.

FIG. 4 is a schematic diagram illustrating reading of the spectrum of light emitted by the two-dimensional code under illumination of ultraviolet light through a UV filter.

FIG. 5 is a sectional view taken along line 5-5 in FIG. 2.

FIGS. 6A to 6C are schematic diagrams sequentially illustrating the steps of the method for marking an information label according to the present invention. FIG. 6A is a diagram illustrating a step for forming a base layer. FIG. 6B is a diagram illustrating a step for forming a surface layer. FIG. 6C is a diagram illustrating a step for forming information label under illumination of laser beam.

### DESCRIPTION OF THE PREFERRED EMBODIMENTS

An embodiment of the present invention is now described with reference to the accompanying drawings.

A video tape cassette is selected as an example for a product in the present embodiment.

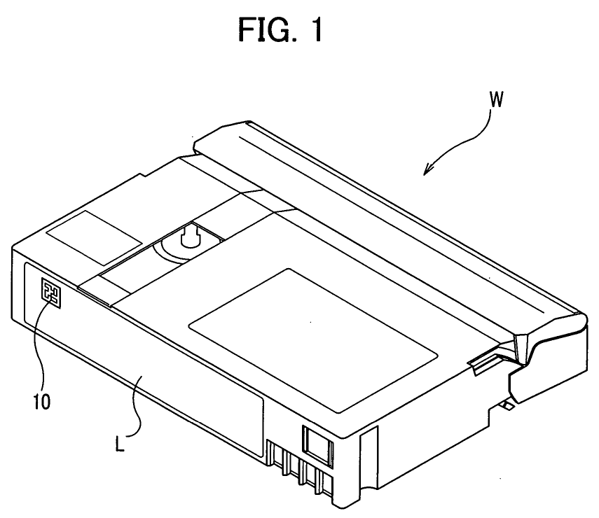

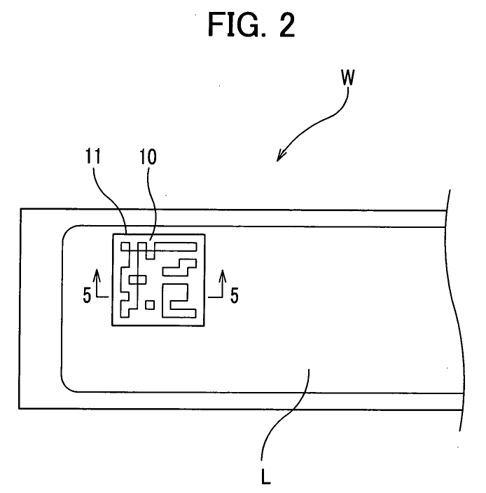

FIGS. 1 and 2 typically show a fluorescent ink emitting light under illumination of ultraviolet light so that the two-dimensional code is visible, for the sake of explanation.

As shown in FIG. 1, a video tape cassette W has a two-dimensional code 10 of information label marked in a fluorescent ink on a portion of a label space L. The code 10 is normally invisible but turns visible only when it is illuminated by ultraviolet light.

The two-dimensional code 10, which is shown enlarged in FIG. 2, is printed on a label 11 in a fluorescent ink, which is excited by ultraviolet light to emit light.

The term “two-dimensional code” is meant to represent an information code, which includes information stored in two dimensions, namely X and Y. A machine is provided to optically read the information contained in the code. The two-dimensional code 10, which is marked in the fluorescent ink on the video tape cassette W, emits fluorescent light when the code 10 is illuminated by ultraviolet light for checking at required points of manufacturing. In this way, the code 10 can be read when it is necessary and used for production control. Following are named as examples for the two-dimensional code 10: CP Code, Data Code, Veri Code, QR Code, PDF417, Calra Code and Maxi Code.

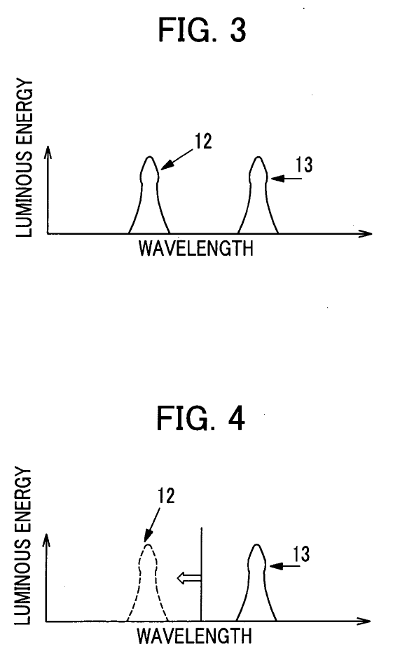

As shown in FIG. 3, when the two-dimensional code 10 is illuminated by ultraviolet light 12, it emits fluorescent light 13 whose wavelength is different from that of the ultraviolet light 12. Accordingly, it may be possible to distinguishably see the code 10. Furthermore, when the code 10 is not illuminated by ultraviolet light, it is invisible.

It may be preferable to read the two-dimensional code 10 through an ultraviolet (UV) filter, which cuts ultraviolet light illuminated for exciting the fluorescent ink. In this way, the ultraviolet light 12 reflected by the surface of video tape cassette W can be cut as shown in FIG. 4, so that it may be possible to see only the fluorescent light 13, being free from an adverse effect caused by the reflected ultraviolet light 12 as well as colors applied to the videotape cassette W. It may be possible to select an appropriate UV filter according to wavelengths of the ultraviolet light used for exciting the fluorescent ink. It may also be possible to adopt another method of digital image processing instead of a physical filter, which employs a technique such as cutting ultraviolet light on a digital image or selecting only the wavelengths of the fluorescent light by filtering on a computer.

It may be possible to arbitrarily select a fluorescent ink as long as it emits fluorescent light under illumination of ultraviolet light. For example, following types of fluorescent ink are known. A first one is an ink made of a rare earth element as an emission center, into which inorganic fluorescent substance such as a fluorescent complex oriented with low molecular weight ligand is dissolved or dispersed. A second one includes an organic fluorescent substance instead of the inorganic fluorescent substance of the first one. They are reported in Japanese Published Patent Applications 8-239607, 6-57191, 7-195820, 9-67531, 9-78012, 9-174996, 9-188835, 9-241551, 9-227817, 9-249834, 10-183037, 10-251584, 11-39419, 11-86032, 11-279474, 11-510213, 11-334214, 2001-246861, 2003-248857, 2003-26968 and 2003-1944. They are also reported in a Japanese Patent Publication 54-22336.

Following are examples for the inorganic fluorescent substance which is made of an oxidized metal or a sulphide combined with a rare earth metal ion or a metal ion as an activation or coactivation agent. The oxidized metal includes such as Y₂O₂S, Zn₂SiO₄ or Ca₅(PO₄)₃C1, the sulphide such as ZnS, SrS or CaS, the rare earth metal ion such as Ce, Pr, Nd, Pm, Sm, Eu, Gd, Tb, Dy, Ho, Er, Tm or Yb, and a metal ion such as Ag, Al, Mn or Sb.

As examples of organic fluorescent substance, fluorescent whitening agents are named, which are manufactured by Showa Kagaku, Showa Kako, Nisso, Kayaku, Mitsui, Sumiotomo, Daito, Ciba and Bayer. Each agent is a derivative of stilbene, 4,4′-diaminostilbene biphenyl, a five membered heterocyclic ring (thoriazole, oxazole or imidazole) or a six membered heterocyclic ring (coumarin, naphthol imido or s-triazine). It may also be possible to select organic fluorescent dyes, which do not absorb light in a visible spectrum but is excited by ultraviolet light to emit visible light such as blue, green, yellowish green or yellow light except for red light. As examples for these dyes, organic fluorescent whitening agents are named, such as coumarin series, stilbene series, triazine series, imidazole series, thiazole series, oxazole series, pyrazolone series and benzooxazine series. Also, metallic complexes are named, which have a rare earth element such as terbium or thulium as an emission center and a counter ion of ligand containing a large number of π electrons. Following are examples for these metallic complexes which are commercially available: “LUMILUX CD301, CD302, CD304, CD770 and CD729” manufactured by Reidel de Haen, “EB-501, EG-302 and EG-307” manufactured by Mitsui Kagaku, and “TINOPAL SK-B” manufactured by Ciba-Geigy.

Of these fluorescent inks, it may be preferable to select those which contain a fluorescent substance that is invisible under visible light conditions and excited to emit light under illumination of ultraviolet light. They do not impose restriction on the design of a product because the information label marked in the inks is invisible under the visible light conditions. It is possible to check the information label by illuminating ultraviolet light on the inks whenever it is necessary. Therefore, being free from the restriction stemming from a color applied to the information label, it may be possible to arbitrarily select various colors in order to identify a product, distinguish it from those of other brands and elaborate its design.

It may be possible to select an appropriate fluorescent substance according to the wavelength of exciting ultraviolet light, the color of fluorescent light, the material of a product, its surface condition and a unit used for reading the information label. For example, a fluorescent ink containing europium emits red fluorescent light, whose wavelength falls in a range of 615±20 nm. Accordingly, it may be possible to detect the information label marked in the ink with high resolution by a silicon photo diode and the like, because the ink, which emits visible light in the above range of longer wavelength under illumination of ultraviolet light, is free from the adverse effect of background color. In this connection, a fluorescent ink containing neodymium, which is excited to emit light under illumination of infrared light, emits light within the spectrum of infrared light under illumination of infrared light that can only be detected by a dedicated detector.

As examples for the solvent, water soluble solvents such as water, polyhydric alcohol, pyrolidone and glycol ether are named.

It may also be possible to select an appropriate additive for a fluorescent ink. For example, a mixture of following known additives can be used: improver for emitting light intensity, reactive diluent, drying accelerator, detergent, surface adjuster, antifoamer, dot adjuster, adhesion agent, adhesion adjuster, cross-linking agent, antimold, moisture preservative, rust-preventive agent, antistatic agent, pH adjuster, lubricant, ultraviolet absorber, antioxidant, electric charge adjuster and stabilizer. Therefore, when the information label is printed by an ink-jet printer, it may be possible to control the viscosity and surface tension of a fluorescent ink, taking into account the stability of printing and conditions of the ink discharged through a ink jet nozzle.

Using one of following types of mill, a container driving mill, a high rotation speed mill and a material stirring mill, or a disperser, a fluorescent ink is prepared. The container-driving mill includes a ball mill, centrifugal mill, planetary ball mill and the like. The high rotation speed mill includes a sand mill and the like. The material stirring mill includes a stirring chamber mill and the like. When a hot-stamp foil including a fluorescent ink is necessary, it is possible to form the foil after kneading a fluorescent substance with the material for the foil.

The two-dimensional code 10 may be printed by any method as long as it marks an information label on a predetermined location of a product. It may be possible to select a method of printing such as hot-stamp printing, ink jet printing, offset printing, gravure printing, thermal transfer printing, screen printing, or letterpress printing. Of these methods, following are shown as typical ones. A first method uses a hot-stamp foil including a fluorescent ink, and the hot-stamp foil is affixed to the product. A second method uses the same type of hot-stamp foil as that of the first method and a blank part of the hot-stamp foil is removed. A third method uses ink jet printing, pad printing and the like, which directly apply the fluorescent ink to the product.

In this connection, the ink jet printing is a method which uses one or more nozzles for discharging the fluorescent ink to form the two-dimensional code 10. The pad printing transfers the ink to the surface of a product in the following manner. The ink is filled in the grooves of an art work that represent characters and patterns. Then the filled ink is transferred to a pad, and the pad is pressed onto the surface of product so that the ink is finally transferred to it. Subsequently, the ink is cured by thermal treatment or illumination of ultraviolet light.

Description is given to steps for marking the two-dimensional code 10 on the label space L of the video tape cassette W by printing.

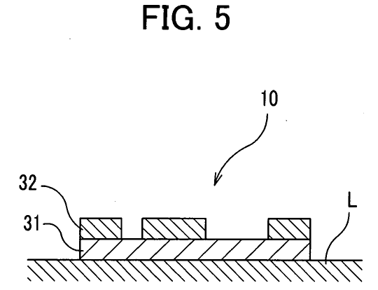

FIG. 5 is a sectional view taken along line 5-5 in FIG. 2.

As shown in FIG. 5, the two-dimensional code 10 has a base layer 31 on the label space L and a surface layer 32 on the base layer 31. The surface layer 32 has partial cutout in a form of groove.

The two-dimensional code 10 is printed on a product in the following manner.

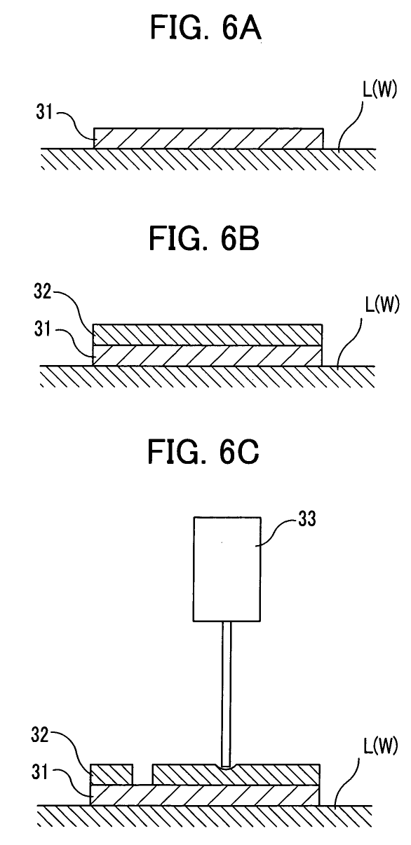

FIGS. 6A to 6C are schematic diagrams illustrating the steps of the method for marking information label according to the present invention. As shown in FIG. 6A, using hot-stamp printing, the base layer 31 is applied to the label space L of video tape cassette W in black. As shown in FIG. 6B, similarly using hot-stamp printing with a fluorescent ink, the surface layer 32 is applied to the base layer 31.

It may be possible to use other known printing methods such as pad printing, screen printing and ink jet printing instead of hot-stamp printing. It is noted that existing printing methods can be widely selected for printing the base layer 31 because it does not require fine printing. It may also be possible to select common coating including a fluorescent ink for the surface layer 32 as long as it can be removed by illumination of laser beam. In this connection, it may be preferable to select a more irremovable coating for the base layer 31 than that for the other layer. The reason for this is that such selection allows less accurate control of laser beam, thereby decreasing defects in printing. Typical measures for this include introduction of an additive for the coating, selection of lighter color which is less likely to absorb laser beam and increasing of the thickness of coating.

In the above description, the base layer 31 and surface layer 32 are applied at the individual steps. Alternatively, it may be possible to apply both base layer 31 and surface layer 32 to the thermal transfer film for hot-stamp printing in advance so that these two layers can be transferred to the video tape cassette W at a time.

Furthermore, the base layer 31 and surface layer 32 are not necessarily cover the same area, but it may be possible to have either one of them occupy a larger area. For example, it may be possible to make the surface layer 32 larger than the base layer 31 so that the former thoroughly covers the latter.

As shown in FIG. 6C, illuminated by a laser beam 33 after application of the surface layer 32, a portion of the surface layer 32 is removed by evaporation using known laser marking. The amount of illumination of laser beam 33 is adjusted so that the base layer 31 is not thoroughly removed. An information label with a predetermined pattern formed by the laser beam 33 is thus completed to make the two-dimensional code 10 shown in FIGS. 1 to 3.

It will now be appreciated from the foregoing description that the present invention is not limited to the particularly illustrated embodiment discussed above and may be carried out in various modified forms.

Although a video tape cassette is selected for a product as an example in the embodiment described above, the method according to the present invention can be applied to other cases for a data recording cassette, audio tape cassette, ink ribbon cartridge for thermal transfer printing, and recording media such as CD-R and DVD-R. It may also generally be possible to apply not only to a case made of plastic but also to a metallic part as well as a ceramic part which has difficulty carving symbols.

It may also be possible to form the surface layer 32 directly on the label space L without the base layer 31. In this case, the two-dimensional code 10 is formed by removing some part of the surface layer 32 by evaporation under illumination of the laser beam 33 after formation of the surface layer 32.

In this way, the information label marked on the predetermined location of a product emits fluorescent light under illumination of ultraviolet light, so that it turns visible. Although it is possible to freely select a light source for excitation as long as it gives good visibility for the information label, it may be preferable to use a common light source with a wavelength of 254 nm or a black light. It may also be possible to use purplish blue light, which has a wavelength of around 405 nm, for excitation light according to fluorescent substances.

What is claimed is:

1. A method for marking an information label on a product comprising the step of printing the information label on the product, wherein the method employs a fluorescent ink which emits light under illumination of ultraviolet light.

2. A method of claim 1, wherein the step of printing further comprises:
preparing a hot-stamp foil to which the fluorescent ink is applied so as to form the information label; and
affixing the hot-stamp foil to the product.

3. A method of claim 1, wherein the step of printing further comprises:
preparing a hot-stamp foil to which the fluorescent ink is applied so as to form the information label;
affixing the hot-stamp foil to the product; and
removing a blank part of the hot-stamp foil.

4. A method of claim 1, wherein the step of printing comprises one of ink jet printing and pad printing which directly apply the fluorescent ink to the product.

5. A method of claim 1, wherein the fluorescent ink comprises a fluorescent substance which is invisible under visible light and emits light under illumination of the ultraviolet light.

6. A method of claim 1, wherein the fluorescent ink emits light in a range of wavelength different from the other range of wavelength of the ultraviolet light, with which the fluorescent ink is illuminated.

7. A method of claim 1, wherein the fluorescent ink emits light in a range of visible light under illumination of the ultraviolet light.

8. A method of claim 1, wherein the information label is read through a filter for cutting the ultraviolet light with which the fluorescent ink is illuminated.

9. A method for marking different information labels on a product comprising the step of printing the information labels on the product, wherein the method employs a plurality of fluorescent inks that emit light in different wavelengths under illumination of ultraviolet light.

10. A method of claim 9, wherein the step of printing further comprises:
preparing at least one hot-stamp foil to which the fluorescent inks are applied so as to form the information labels; and
affixing the hot-stamp foil to the product.

11. A method of claim 9, wherein the step of printing further comprises:
preparing at least one hot-stamp foil to which the fluorescent inks are applied so as to form the information labels;
affixing the hot-stamp foil to the product; and
removing a blank part of the hot-stamp foil.
